(19) United States
(12) Patent Application Publication
(10) Pub. No.: US 2020/0337493 A1
(43) Pub. Date: Oct. 29, 2020

(54) MOTION RECORDING DEVICE OF BREWING POUR OVER COFFEE

(71) Applicant: QOFII INC., Taipei City (TW)

(72) Inventors: Yi-Chun Chen, Taipei City (TW); Chien-Lung Huang, Taipei City (TW); Wei-Cheng Hong, Taipei City (TW); Yi-Da Ciou, Taipei City (TW); Ta-Wei Yeh, Taipei City (TW)

(21) Appl. No.: 16/779,684

(22) Filed: Feb. 3, 2020

(30) Foreign Application Priority Data
Apr. 24, 2019 (TW) 108114378

(51) Int. Cl. A47J 31/56; A47J 31/40; A47J 31/00; A47J 31/44

(52) U.S. Cl. CPC A47J 31/56; A47J 31/402; B25J 11/008; A47J 31/4457; A47J 31/002

(57) ABSTRACT

A motion recording device of brewing pour over coffee used to record the process of a user brewing pour over coffee, comprises a water injection unit, a displacement sensing module, a water volume sensing module and a recording unit. The water injection unit is connected to a working platform. The user can move the water injection unit to pour water from the water injection unit. The displacement sensing module is disposed on the working platform and used to measure the change of the position of the water injection unit during the process of pouring water. The water volume sensing module is used to measure the change of the water volume poured out from the water injection unit during the process of pouring water. The recording unit is used to record the change of the position the water injection unit and the change of the water volume poured out from the water injection unit during the process of pouring water.

### RELATED APPLICATIONS

The present application claims the priority of Taiwan Application No. 108114378, filed Apr. 24, 2019, the disclosure of which is hereby incorporated by reference herein in its entirety.

### BACKGROUND OF THE INVENTION

### 1. Field of the Invention

The present disclosure generally relates to a motion recording device, and, more particularly, to a motion recording device for recording and digitizing the process of brewing pour over coffee.

### 2. Description of the Related Art

Brewing pour over coffee involves pouring hot water over coffee grounds and extracting coffee through the filter paper and coffee dripper. Because the flow rate, direction, water injection point and temperature of the hot water are controlled by the barista, the flavor of the coffee brewed would be different almost every time. Although the appliance is simple, brewing pour over coffee relies on the barista's skills and experiences.

Compared with other coffee brewing methods, there are quite a lot of factors influencing pour over coffee brewing. It is required to do enough research and preparation before brewing. Each pour over coffee barista may use different brewing method, for example, pour over path, water temperature, volume control, etc.

Therefore, how to use modern technology equipment and scientific methods to reproduce the brewing skills of pour over coffee barista through digital recording, which has become an problem to be solved in the industry.

### SUMMARY OF THE INVENTION

In light of solving the foregoing problems of the prior art, the present invention provides a motion recording device of brewing pour over coffee, used to record the process of a user brewing pour over coffee. The motion recording device comprises a water injection unit connected to a working platform, wherein the user moves the water injection unit to pour water from the water injection unit; a displacement sensing module disposed on the working platform and used to measure the change of the position of the water injection unit during the process of pouring water; a water volume sensing module used to measure the change of the water volume poured out from the water injection unit during the process of pouring water; and a recording unit used to record the change of the position and the change of the water volume poured out from the water injection unit during the process of pouring water.

In an embodiment of the present invention, the working platform comprises a mechanical device to mark and control the movement of an object depending on a rectangular coordinate system. The water injection unit is disposed on the working platform and moves along a motion route provided by the mechanical device.

In an embodiment, the displacement sensing module comprises an optical linear scale measuring module for measuring the change of the position of the water injection unit.

In an embodiment, the displacement sensing module comprises a magnetic linear scale measuring module for measuring the change of the position of the water injection unit.

In an embodiment, the working platform comprises a mechanical device to mark and control the movement of an object depending on a spherical coordinate system. The water injection unit is disposed on the working platform and moves along a motion route provided by the mechanical device.

In an embodiment, the displacement sensing module comprises an angular displacement sensing unit and a linear displacement sensing unit for measuring the change of the position of the water injection unit.

In an embodiment, the motion recording device of brewing pour over coffee further comprises a servo motor connected to the working platform The servo motor receives a feedback signal generated by the water injection unit when the water injection unit moves in order to measure the change of the position of the water injection unit.

In an embodiment, the water volume sensing module comprises a gyro disposed on the water injection unit. The gyro is used to measure the inclination of the water injection unit, which is recorded by the recording unit.

In an embodiment, the water volume sensing module comprises a cup and a weighing scale. The cup is disposed under the water injection unit and located on the weighing scale. The cup and the weighing scale are used to measure the water volume of the water injection unit, which is recorded by the recording unit.

In an embodiment, the water injection unit comprises a knob or a button for the user to rotate or press to adjust the water volume poured out from the water injection unit.

Compared to the prior art, the motion recording device of brewing pour over coffee according to the present invention allows a user to manually move and control the water injection unit which is disposed on the working platform. The water injection unit and the working platform are linked by the slide rails of the working platform to forms a mechanical linkage, which means the working platform reflects the motion route of the water injection unit. Then, the displacement sensing module, the water volume sensing module and the gyro are used to sense/measure the change of the position of the water injection unit, the change of the water volume poured out by the water injection unit and the inclination of the water injection unit, respectively. The recording unit is used to record those parameters. The data measured by the motion recording device of brewing pour over coffee according to the present invention can be analyzed and used to reproduce the pour over coffee brewing process by any barista.

### BRIEF DESCRIPTION OF THE DRAWINGS

FIG. 1 and FIG. 2 illustrate schematic views of embodiments according to the present invention.

### DETAILED DESCRIPTION

The present invention is described by the following specific embodiments. Those with ordinary skills in the arts can readily understand other advantages and functions of the present invention after reading the disclosure of this specification. Any changes or adjustments made to their relative relationships, without modifying the substantial technical contents, are also to be construed as within the range implementable by the present invention.

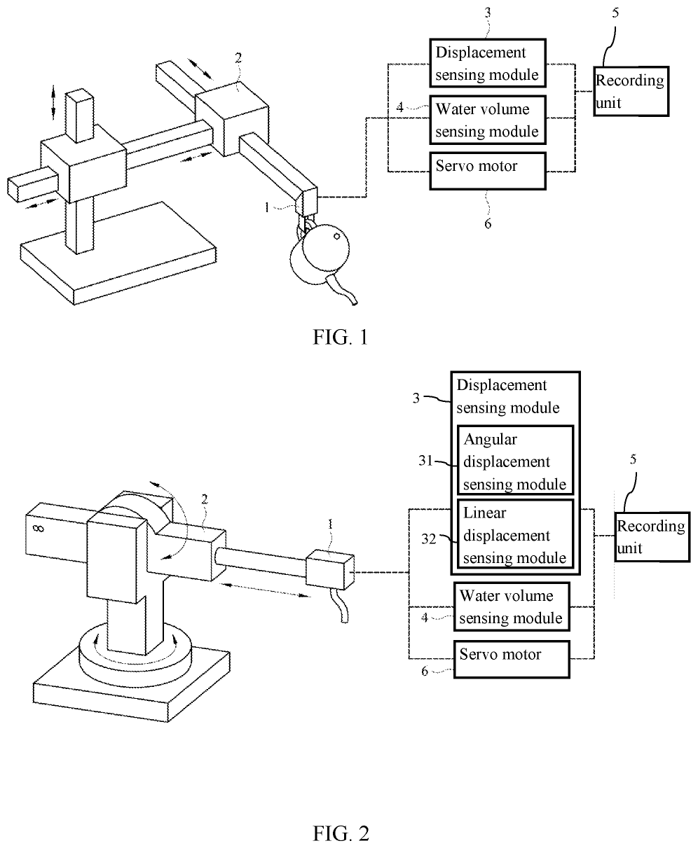

Please refer to FIG. 1. FIG. 1 illustrates a schematic view of one of the embodiments of the motion recording device of brewing pour over coffee according to the present invention. As shown, the motion recording device of brewing pour over coffee according to the present invention mainly comprises a water injection unit 1 connected to a working platform 2. The user can manually hold and move the water injection unit 1 or move the water injection unit 1 by controlling a linkage mechanical structure of the working platform 2 to simulate the action of pouring water to brew a pour over coffee. The water injection unit 1 and the working platform 2 may be linked by the slide rails of the working platform. During the process of pouring water, the slide rails of the work platform 2 may be driven by the user. A displacement sensing module 3 and a water volume sensing module 4 may be disposed on the working platform 2. The displacement sensing module 3 may be used to measure the change of the position of the water injection unit 1 during the process of pouring water. The water volume sensing module 4 may be used to measure the change of the water volume poured out from the water injection unit 1 during the process of pouring water. The change of the position (displacement) and the change of the water volume poured out from the water injection unit obtained from the displacement sensing module 3 and the water volume sensing module 4, respectively, are collected and stored by a recording unit 5.

As shown in FIG. 1. In an embodiment, the working platform 2 may comprise a mechanical device which may be used to mark and control the movement of an object depending on a rectangular coordinate system. More particularly, the working platform 2 may be a XYZ table. The XYZ table may allow the water injection unit 1 to move without limits in space along X, Y and Z axis by using a combination of linear slide rails in three-dimensional directions (XYZ axes), in which case the water injection unit 1 may move along a motion route provided by the mechanical device; alternatively, the water injection unit 1 may be moved by the user and the mechanical device may reflect the motion route of the water injection unit simultaneously. FIG. 1 is for illustrative purposes only, and the mechanism is not limited thereto. Please refer to FIG. 2. In another embodiment, the working platform 2 may comprise a mechanical device which may be used to mark and control the movement of an object depending on a spherical coordinate system. The mechanical device may allow the water injection unit 1 to move freely without limits in space by a combination of two rotating shafts with different directions and a linear slide rail, in which case the water injection unit 1 may move along a motion route provided by the mechanical device; alternatively, the water injection unit 1 may be moved by the user and the mechanical device may reflect the motion route of the water injection unit simultaneously.

In the case of the working platform 2 comprising the mechanical device depending on a rectangular coordinate system, as shown in FIG. 1, the displacement sensing module 3 can be an optical linear scale measuring module for measuring the change of the position of the water injection unit 1. The principle of optical linear scale is to apply grating stripe and photoelectric conversion technology. A chrome-plated scale is placed on a glass to form a transparent length ruler which is then adhered to an aluminum ruler, and the measurement may be made by the feedback of light refraction or transmission to the sensor. Alternatively, the displacement sensing module 3 can also be a magnetic linear scale measuring module. The principle of a magnetic linear scale is similar to the recording technique. Writing magnetic waves with strictly equal intervals on a magnetic tape (or disk) by a magnetic head as magnetic grids, and the distance between adjacent grids on the magnetic tape are as scales (pitch). The optical linear scale measuring module or the magnetic linear scale measuring module can be installed on the linear slide rails of the working platform 2 shown in FIG. 1 in every dimension (X,Y, and/or Z direction) to detect the change of the water injection unit 1 in every dimension to further measure the position and movement route of the water injection unit 1 in space.

In the case of the working platform 2 the mechanical device depending on a spherical coordinate system, as shown in FIG. 2, then the change of the position of the water injection unit 1 may include the change of the angle and the change of the straight line distance. Therefore, the displacement sensing module 3 may comprise two different types of sensing units, such as an angular displacement sensing unit 31 and a linear displacement sensing unit 32, for measuring angular variation (angular displacement) and linear distance variation (displacement), respectively. The angular displacement sensing unit 31 and the linear displacement sensing unit 32 may be respectively mounted on each of the two rotating shafts with different directions and the linear slide rails to detect angular variation (angular displacement) and linear distance variation (displacement) of the water injection unit 1 in every dimension to further measure the position and movement route of the water injection unit 1 in space.

In another embodiment of the present inventive concept, the change of the position of the water injection unit 1 may be measured not only by the displacement sensing module 3 disposed on the work platform 2, but also by the characteristics of feedback signal received by the servo motor 6. It should be noted that, in general, the servo motor 6 may be disposed on the working platform 2 to drive the slide rails or the rotating shafts of the working platform 2 to control the movement of the object in the space. The servo motor 6 may further receive the feedback signals of the change of the position from the slide rails or the change of the angle from the rotating shafts. By doing so, when the user controls and moves the water injection unit 1 to pour water, the servo motor 6 is in neutral to avoid the water injection unit 1 driven by the servo motor 6. However, the change of the position of the water injection unit 1 may be determined by the feedback signals received by the servo motor 6. Therefore, when the user manually moves the water injection unit 1 (the servo motor 6 is kept in neutral), the change of the position of the water injection unit 1 can be determined by the feedback signals received by the servo motor 6. The feedback signals can also be collected and stored by the recording unit 5.

The foregoing are some of the embodiments of the working platform 2 of the concept of present inventive. Some embodiments of the water injection unit 1 of the concept of present inventive are illustrated as follows. For example, the water injection unit 1 may be a kettle gripped by a rotatable gripping claw to pour water, as shown in FIG. 1, and the water injection unit 1 may be a rotatable water injection head with a nozzle, as shown in FIG. 2. The water volume sensing module 4 may include a gyro disposed on the water injection unit 1 or directly disposed on the kettle. The gyro is used to measure the inclination of the water injection unit 1 or the kettle when the water is poured therefrom, which is recorded by the recording unit 5. In an embodiment, the water volume sensing module 4 may comprise a cup and a weighing scale. The cup may be disposed under the water injection unit 1 and located on the weighing scale. The water injection unit 1 may inject water into the cup, and the amount of water in the cup may be weighed out by the scale, thereby to measure the instantaneous volume of water poured into the cup by the water injection unit 1 which is recorded by the recording unit 5. The correspondence between the inclination of the water injection unit 1 and the water volume poured from the water injection unit may be derived from the instantaneous water injection volume measured by the weighing scale, such as the rate of the increasing volume of water. Therefore, the water volume poured from the injection unit may be adjusted by adjusting the inclination of the water injection unit 1.

Further, in another embodiment of the present inventive concept, the water injection unit 1 may be designed to comprise a handle with a push button (not shown in the figures) for the user to hold handle with one hand and press the button to adjust the water volume. Alternatively, the water injection unit 1 may be designed to comprise a handle with a knob (not shown in the figures). The user can rotate the knob to adjust the water volume while holding the handle during the process of pouring water.

In summary, the motion recording device of brewing pour over coffee according to the present invention comprises the water injection unit connecting to the working platform. It allows the user to manually move and control the water injection unit disposed on the working platform for the process of pouring water for brewing pour over coffee and the working platform may reflect the motion route of the water injection unit by the slide rails of the working platform. Then the change of the position and the water volume poured out from the water injection unit during the process may be measured by the displacement sensing module and the water volume sensing module. Thereby the process of pouring water for brewing pour over coffee may be recorded digitized.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A motion recording device of brewing pour over coffee, used to record the process of a user brewing pour over coffee, the motion recording device comprising:
a working platform;
a water injection unit connected to the working platform, enabling the user moves the water injection unit to pour water from the water injection unit;
a displacement sensing module disposed on the working platform and used to measure the change of the position of the water injection unit during the process of pouring water;
a water volume sensing module used to measure the change of the water volume poured out from the water injection unit during the process of pouring water; and
a recording unit, used to record the change of the position of the water injection unit and the change of the water volume poured out from the water injection unit during the process of pouring water.

2. The motion recording device of brewing pour over coffee of claim 1, wherein the working platform comprises a mechanical device to mark and control the movement of an object depending on a rectangular coordinate system, and the water injection unit moves along a motion route provided by the mechanical device.

3. The motion recording device of brewing pour over coffee of claim 2, wherein the displacement sensing module comprises an optical linear scale measuring module for measuring the change of the position of the water injection unit.

4. The motion recording device of brewing pour over coffee of claim 2, wherein the displacement sensing module comprises a magnetic linear scale measuring module for measuring the change of the position of the water injection unit.

5. The motion recording device of brewing pour over coffee of claim 1, wherein the working platform comprises a mechanical device to mark and control the movement of an object depending on a spherical coordinate system, and the water injection unit moves along a motion route provided by the mechanical device.

6. The motion recording device of brewing pour over coffee of claim 5, wherein the displacement sensing module comprises an angular displacement sensing unit and a linear displacement sensing unit for measuring the change of the position of the water injection unit.

7. The motion recording device of brewing pour over coffee of claim 1, further comprising a servo motor connected to the working platform, wherein the servo motor receives a feedback signal generated by the water injection unit when the water injection unit moves in order to measures the change of the position of the water injection unit.

8. The motion recording device of brewing pour over coffee of claim 1, wherein the water volume sensing module comprises a gyro disposed on the water injection unit, wherein the gyro is used to measure the inclination of the water injection unit, which is recorded by the recording unit.

9. The motion recording device of brewing pour over coffee of claim 1, wherein the water volume sensing module comprises a cup and a weighing scale, wherein the cup is under the water injection unit and located on the weighing scale, and the cup and the weighing scale are used to measure the water volume poured from the water injection unit, which is recorded by the recording unit.

10. The motion recording device of brewing pour over coffee of claim 1, wherein the water injection unit comprises a knob or a button for the user to rotate or press to adjust the water volume poured out from the water injection unit.
